(19) United States
(12) Patent Application Publication
(10) Pub. No.: US 2024/0275514 A1
(43) Pub. Date: Aug. 15, 2024

(54) OPTICAL COMMUNICATION SYSTEM

(71) Applicant: FUJIFILM Corporation, Tokyo (JP)

(72) Inventors: Kazuya HISANAGA, Minamiashigara-shi (JP); Yujiro YANAI, Minamiashigara-shi (JP); Makoto KAMO, Minamiashigara-shi (JP)

(73) Assignee: FUJIFILM Corporation, Tokyo (JP)

(21) Appl. No.: 18/627,762

(22) Filed: Apr. 5, 2024

Related U.S. Application Data
(63) Continuation of application No. PCT/JP2022/037202, filed on Oct. 5, 2022.

(30) Foreign Application Priority Data
Oct. 8, 2021 (JP) 2021-165927
Sep. 26, 2022 (JP) 2022-152673

(51) Int. Cl. H04J 14/06; G02B 5/30; H04B 10/532

(52) U.S. Cl. CPC H04J 14/06; G02B 5/3083; H04B 10/532

(57) ABSTRACT

According to the present invention, a multiplexing optical communication system including a simple and high-efficiency optical system can be provided. The optical communication system includes an optical transmitter, a transmission path, and an optical receiver, in which the optical transmitter includes a polarized light source, a polarizing plate, a patterned retardation plate that converts light from the polarized light source into a plurality of optical vortices, a modulator, and a multiplexer.

### CROSS-REFERENCE TO RELATED APPLICATIONS

This application is a Continuation of PCT International Application No. PCT/JP2022/037202 filed on Oct. 5, 2022, which claims priority under 35 U.S.C. § 119(a) to Japanese Patent Application No. 2021-165927 filed on Oct. 8, 2021 and Japanese Patent Application No. 2022-152673 filed on Sep. 26, 2022. The above applications are hereby expressly incorporated by reference, in their entirety, into the present application.

### BACKGROUND OF THE INVENTION

### 1. Field of the Invention

The present invention relates to an optical communication system.

### 2. Description of the Related Art

The Internet traffic has increased every year, and an increase in capacity is also required for an optical communication system which is a backbone network.

In order to realize an increase in capacity in the optical communication system, an optical communication system by space-division multiplexing has been considered. For example, Georg Rademacher, Benjamin J. Puttnam, Ruben S. Luis, Tobias A. Eriksson, Nicolas K. Fontaine, Mikael Mazur, Haoshuo Chen, Roland Ryf, David T. Neilson, Pierre Sillard, Frank Achten, Yoshinari Awaji and Hideaki Furukawa, Nature Communications, vol. 12, Article number: 4238, 2021 discloses an optical communication system using light components in 15 different modes.

### SUMMARY OF THE INVENTION

However, in the related art, a complicated reflective optical system is required to convert between the light modes, and further there is a problem in that the conversion efficiency is low.

Accordingly, an object of the present invention is to provide a multiplexing optical communication system including a simple and high-efficiency optical system.

As a result of a thorough investigation, the present inventors found that a multiplexing optical communication system including a simple and high-efficiency optical system can be provided by applying a patterned retardation plate and adopting a configuration in which a plurality of incident rays or expanded incident light is converted into a plurality of optical vortices in different modes simply by passing through the patterned retardation plate once.

That is, the present inventors found that the object can be achieved with the following configurations.

[1] An optical communication system comprising:
an optical transmitter;
a transmission path; and
an optical receiver,
in which the optical transmitter includes a polarized light source, a patterned retardation plate that converts light from the polarized light source into a plurality of optical vortices, a modulator, and a multiplexer.

[2] The optical communication system according to [1],
in which a plurality of the polarized light sources are provided or the single polarized light source is widely distributed, and the modulator is provided between the patterned retardation plate and the multiplexer.

[3] The optical communication system according to [1],
in which a plurality of the polarized light sources are provided, and the modulator is provided between each of the polarized light sources and the patterned retardation plate.

[4] The optical communication system according to any one of [1] to [3],
in which in the patterned retardation plate, an azimuthal angle of an in-plane slow axis changes around one point.

[5] The optical communication system according to any one of [1] to [4],
in which in the patterned retardation plate, in a case where an azimuthal angle of the slow axis rotates once around one point, the azimuthal angle of the slow axis continuously changes by α×180° (a represents an integer).

[6] The optical communication system according to any one of [1] to [5], further comprising:
a polarizing plate,
in which the polarizing plate and the patterned retardation plate are integrated.

[7] The optical communication system according to any one of [1] to [6], comprising:
an alignment mechanism capable of accurately aligning a center of the patterned retardation plate and an incident position of light with each other.

[8] The optical communication system according to any one of [1] to [7],
in which the patterned retardation plate includes, in the same plane, a plurality of phase difference patterns that are different in at least one of an order or the number of nodes.

[9] A patterned retardation plate comprising:
a plurality of phase difference patterns that convert incident polarized light into optical vortices,
in which the plurality of phase difference patterns that are different in at least one of an order or the number of nodes are provided in the same plane.

According to the present invention, a multiplexing optical communication system including a simple and high-efficiency optical system can be provided.

### BRIEF DESCRIPTION OF THE DRAWINGS

FIG. 1 is a conceptual diagram showing an optical communication system 1 according to a first embodiment.

FIG. 2 is a schematic diagram showing slow axis distributions of phase difference patterns used for the present invention.

FIG. 3 is a conceptual diagram showing an optical communication system 2 according to a second embodiment.

FIG. 4 is a diagram showing a relationship between a phase of the phase difference pattern and an orientation of a liquid crystal compound.

FIG. 5 is a conceptual diagram showing an example of the phase difference patterns used in the present invention using phase distributions.

FIG. 6 is a diagram showing each of phase difference patterns using a phase distribution and a slow axis distribution.

FIG. 7 is a diagram showing each of phase difference patterns using a phase distribution and a slow axis distribution.

FIG. 8 is a conceptual diagram showing another example of the phase difference patterns used in the present invention using a phase distribution.

FIG. 9 is a conceptual diagram showing an exposure mask that is used for preparing the phase difference pattern used in the present invention and showing a polarization direction of light to be exposed.

FIG. 10 is a conceptual diagram showing an exposure mask that is used for preparing the phase difference pattern used in the present invention and a polarization direction of light to be exposed.

FIG. 11 is a conceptual diagram showing an exposure mask that is used for preparing the phase difference pattern used in the present invention and a polarization direction of light to be exposed.

FIG. 12 is a conceptual diagram showing an exposure mask used for preparing each of phase difference patterns.

FIG. 13 is a conceptual diagram showing an exposure mask used for preparing each of phase difference patterns.

FIG. 14 is a conceptual diagram showing an exposure mask used for preparing each of phase difference patterns.

### DESCRIPTION OF THE PREFERRED EMBODIMENTS

Hereinafter, embodiments of the present invention will be described in detail with reference to the drawings. Note that the present invention can be implemented in various different embodiments and does not limit the following embodiments.

### First Embodiment

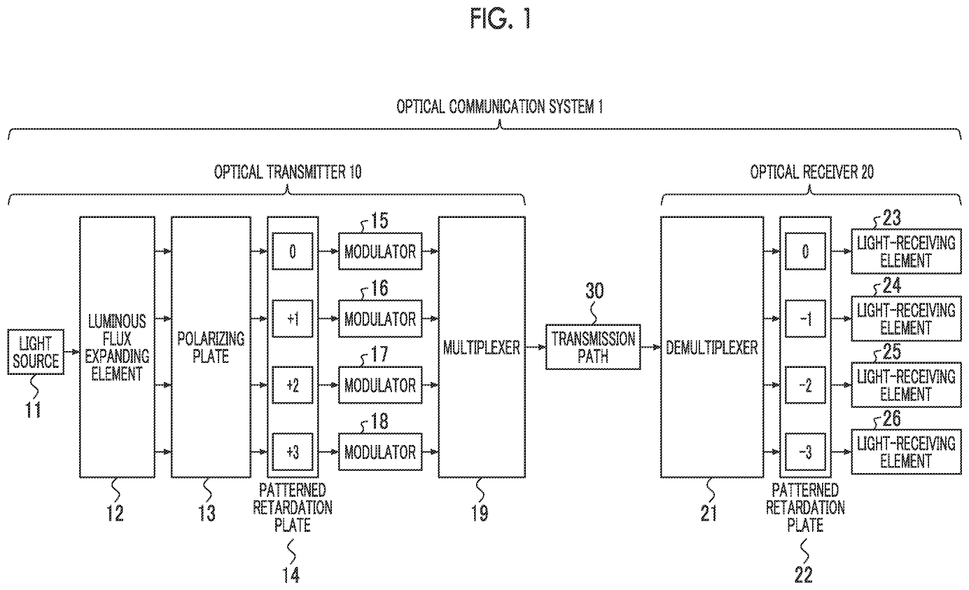

FIG. 1 is a conceptual diagram showing a configuration of an optical communication system according to a first embodiment of the present invention. The optical communication system 1 includes an optical transmitter 10 that transmits a plurality of signal light components, an optical receiver 20 that receives the plurality of signal light components transmitted from the optical transmitter 10, and a transmission path 30 that connects the optical transmitter 10 and the optical receiver 20 to each other.

### <Optical Transmitter>

The optical transmitter 10 includes a light source 11, a luminous flux expanding element 12, a polarizing plate 13, a patterned retardation plate 14, modulators 15 to 18, and a multiplexer 19. The light source 11 needs to be a polarized light source. However, the light source itself may emit polarized light, and the light source may include a polarizing plate.

The emitted light of the light source 11 is preferably near infrared light. The near infrared light is light in a wavelength range of 700 nm to 2500 nm. As the light source 11, for example, a light emitting diode (LED) or a laser light source can be used.

The light emitted from the light source 11 is incident into the luminous flux expanding element 12 and is expanded in a horizontal direction. As the luminous flux expanding element 12, for example, a cylindrical lens or a microlens (a combination of a convex lens and a concave lens) can be used.

The expanded light is incident into the polarizing plate 13 and converted into linearly polarized light. The polarizing plate 13 is not particularly limited as long as it has a polarization degree corresponding to a wavelength of the light source 11, and any of an absorptive type or a reflective type can be used.

In order to perform high-efficiency multiplexing optical communication, it is necessary to superimpose light components in a state where the light components do not interfere with each other.

In this case, for the multiplexing optical communication, the light components are superimposed depending on optical vortices that are different in a helical direction of a helical structure and a pitch thereof.

The linearly polarized light is incident into the patterned retardation plate 14 and converted into an optical vortex corresponding to each of orders. The patterned retardation plate 14 includes a plurality of phase difference patterns that convert the incident linearly polarized light into optical vortices. In the patterned retardation plate 14 and a patterned retardation plate 22 described below, each of phase difference patterns having orders of m's (m represents an integer) is arranged in a horizontal direction. FIG. 1 shows a case where the orders of the phase difference patterns in the patterned retardation plate 14 and the patterned retardation plate 22 are m=0, +1, +2, and +3, but the present invention is not limited thereto. The number of the phase difference patterns in the patterned retardation plate may be 2 to 3 or may be 5 or more. That is, optionally, the number of m's can be adjusted. In addition, the orders m of the phase difference pattern in the patterned retardation plate are not limited to m=0 to ±3 and may be +4 or more or −4 or less. In addition, the orders m's of the phase difference patterns in the patterned retardation plate are not limited to being continuous and may be discrete. For example, the patterned retardation plate may include phase difference patterns having orders of m=0, ±2, ±3, and ±5.

In each of the phase difference patterns, it is preferable that an azimuthal angle of an in-plane slow axis continuously or discretely changes around one point in a circumferential direction, and it is more preferable that, in a case where the azimuthal angle of the slow axis rotates once around one point, the azimuthal angle of the slow axis discretely or continuously changes by α×180° (a represents an integer). In this case, the point represents a point around which the pattern is formed without representing any point.

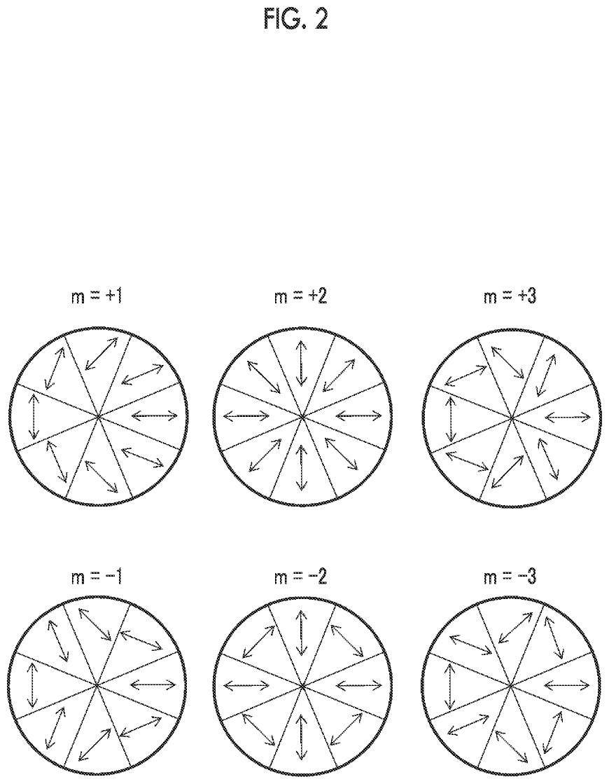

FIG. 2 is a schematic diagram showing slow axis distributions of phase difference patterns having m=±1 to ±3 as an example of the patterns. Here, in a case where m=+1 and an orientation of a slow axis rotates once to the left (counterclockwise) around a center point, the orientation of the slow axis changes to the left (counterclockwise) by 180°. In a case where m=+2 and an orientation of a slow axis rotates once to the left (counterclockwise) around a center point, the orientation of the slow axis changes to the left (counterclockwise) by 360°. In addition, in a case where m=−1 and an orientation of a slow axis rotates once to the left (counterclockwise) around a center point, the orientation of the slow axis changes to the right (clockwise) by 180°. In a case where m=−2 and an orientation of a slow axis rotates once to the left (counterclockwise) around a center point, the orientation of the slow axis changes to the right (clockwise) by 360°.

A phase difference between the patterned retardation plate 14 and the patterned retardation plate 22 is preferably λ/2 with respect to a wavelength λ of an incidence ray. By causing linearly polarized light to be incident into the phase difference pattern having the slow axis distribution and the phase difference described above, an optical vortex having an order of α=m can be formed.

The phase difference patterns in the patterned retardation plates 14 and 22 can be prepared using a well-known method. As a specific example of the method, the phase difference patterns in the patterned retardation plates 14 and 22 can be prepared using a method described in JP2008-233903.

The polarizing plate 13 and the patterned retardation plate 14 may be integrated. As the integration method, a well-known bonding method using a pressure sensitive adhesive and/or an adhesive may be used. By integrating the polarizing plate 13 and the patterned retardation plate 14, loss of light caused by reflection from an air interface can be reduced, and the number of members can be reduced. Therefore, there is an advantageous effect in that the assembly is simple.

It is preferable that the patterned retardation plate 14 and the patterned retardation plate 22 described below include an alignment mechanism capable of accurately aligning an incident position of an incidence ray and a center of each of the phase difference patterns with each other. By accurately aligning the incident position of the incidence ray and the center of each of the phase difference patterns with each other, the conversion efficiency can be maximized, and the S/N ratio of communication is improved.

A plurality of optical vortices formed by causing the incidence ray to pass through the phase difference patterns are incident into the modulators 15 to 18, respectively.

Each of the modulators 15 to 18 modulates an amplitude of the optical vortex incident thereinto.

The modulation of the amplitude is performed on only an optical vortex having an order corresponding to a required signal by each of the modulators 15 to 18. The modulation of the amplitude may be two-stage digital modulation or may be multi-stage modulation. As the modulators 15 to 18, for example, a MEMS (Micro-Electro-Mechanical Systems) mirror or a LCOS (Liquid Crystal On Silicon) element can be used.

The modulators 15 to 18 allocate different signals to the optical vortices, respectively.

The optical vortices modulated by the modulators 15 to 18 are multiplexed by the multiplexer 19 and transmitted to the transmission path 30.

The multiplexer 19 is not particularly limited, and various known multiplexers can be used.

### <Transmission Path>

The optical vortices passed through the modulators 15 to 18 are multiplexed by the multiplexer 19 and transmitted to the optical receiver 20 through the transmission path 30. The transmission path 30 may be a free space and is preferably an optical fiber from the viewpoints of the S/N ratio and the stability. The optical fiber is not particularly limited, and any optical fiber that is generally used in an optical communication system can be used.

### <Optical Receiver>

As the optical receiver 20 configuring the optical communication system according to the embodiment of the present invention, any light receiving device for an optical vortex can be applied. That is, as the optical receiver 20, any optical receiver that can reproduce a signal from an amplitude of each of channels after demultiplexing the optical vortex with an appropriate demultiplexer can be used.

The configuration shown in FIG. 1 is a preferable example of the optical receiver 20. The optical receiver 20 includes a demultiplexer 21, the patterned retardation plate 22, and light-receiving elements 23 to 26. The transmitted optical signal (multiplexed optical vortex) is demultiplexed by the demultiplexer 21 such that the demultiplexed signals can be incident into the phase difference patterns of the patterned retardation plate 22, respectively.

In the patterned retardation plate 22, phase difference patterns having the same absolute values as the orders of the phase difference patterns in the patterned retardation plate 14 but having different signs from the orders are disposed. In a case where an optical signal is incident into the phase difference patterns having the same absolute values as the orders of the optical vortices passed through the modulators 15 to 18 but having different signs from the orders, zero-order light where the intensity of light in the center portion is the maximum is formed. On the other hand, in a case where optical vortices having different absolute values are incident, zero-order light is not formed, and a donut-shaped light intensity distribution of the optical vortices is maintained. Therefore, the intensity of light in the center portion is 0. That is, each of the phase difference patterns in the patterned retardation plate 22 strengthens the intensity of light in the center portion of the optical vortex having the corresponding order. The light passed through the phase difference patterns in the patterned retardation plate 22 is received by the light-receiving elements 23 to 26, and in a case where the intensity of light in the center portion is measured, only the optical signal corresponding to the order of the passed optical vortex is detected by the optical transmitter 10. As a result, the signal allocated to each of the optical vortices can be detected.

As described above, in the optical communication system 1 according to the first embodiment, multiplexing optical communication where an optical system is simple and has high efficiency can be realized using the optical vortices formed by the phase difference patterns.

### Second Embodiment

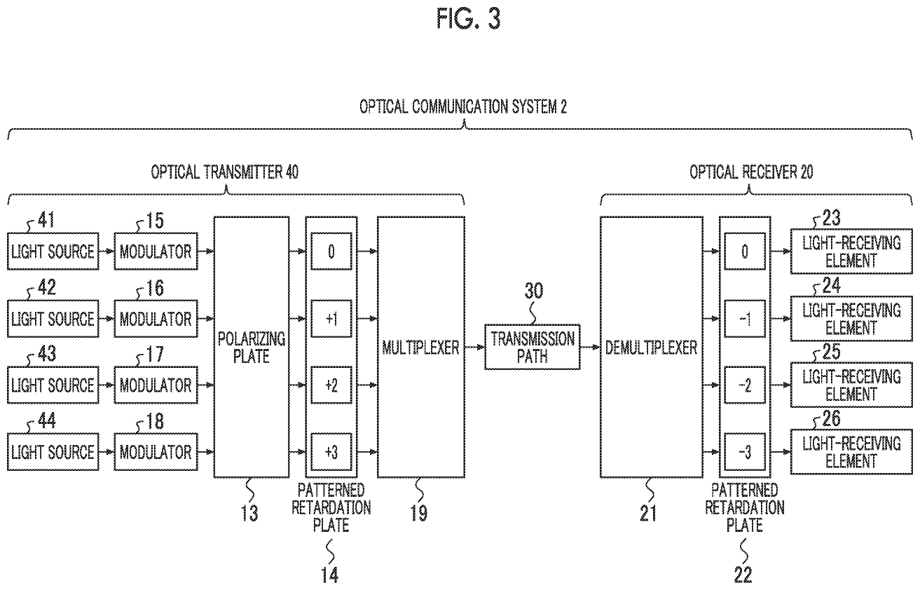

FIG. 3 is a conceptual diagram showing a configuration of an optical communication system 2 according to a second embodiment of the present invention. In FIG. 3, components identical to or corresponding to the components shown in FIG. 1 are represented by the same reference numerals as those shown in FIG. 1. The second embodiment is different from the first embodiment, in that an optical transmitter 40 includes a plurality of light sources 41 to 44, that the luminous flux expanding element 12 is not provided, and that the modulators 15 to 18 are disposed between the light sources 41 to 44 and the polarizing plate 13. Except these points, the second embodiment is the same as the first embodiment.

### <Optical Transmitter>

The optical transmitter 40 includes the light sources 41 to 44, the modulators 15 to 18, the polarizing plate 13, the patterned retardation plate 14, and a multiplexer 16. The light sources 41 to 44 are disposed by the same number as the number of the phase difference patterns disposed in the patterned retardation plate 14, and a signal can be switched by turning ON/OFF of the light sources 41 to 44 or by performing the modulation using the modulators 15 to 18. The light sources 41 to 44 are not particularly limited, and any light source that is generally used in an optical communication system can be used. Light emitted from the light sources 41 to 44 is preferably near infrared light.

### <Transmission Path and Optical Receiver>

The light emitted from the light sources 41 to 44 is incident into the polarizing plate 13 and converted into linearly polarized light, the linearly polarized light is incident into the phase difference pattern having the orders in the patterned retardation plate 14 to form optical vortices having the orders, and the optical vortices are integrated by the multiplexer 19. Subsequently, the transmission path 30 and the optical receiver 20 are the same as those of the first embodiment.

As described above, in the optical communication system 2 according to the second embodiment, multiplexing optical communication where an optical system is simple and has high efficiency can be realized using the optical vortices formed by the phase difference patterns.

In the example shown in FIG. 3, the optical communication system 2 is configured to include the modulators 15 to 18 between the light sources 41 to 44 and the polarizing plate 13, but the present invention is not limited thereto. The optical communication system 2 may be configured to include the modulators 15 to 18 between the patterned retardation plate 14 and the multiplexer 19.

In addition, in the above-described example, the patterned retardation plate is configured to include a plurality of phase difference patterns that are arranged in one direction. However, the present invention is not limited thereto, and a plurality of phase difference patterns may be two-dimensionally arranged. In a case where the phase difference patterns are two-dimensionally arranged, the luminous flux expanding element may expand light in two directions orthogonal to each other, and a plurality of light sources may be two-dimensional periodically arranged according to the arrangement of the phase difference patterns. Alternatively, a plurality of light sources may be arranged in one direction, and light components emitted from the light sources may be expanded in directions orthogonal to arrangement directions of the light sources by a plurality of luminous flux expanding elements, respectively.

Hereinafter, the phase difference patterns in the patterned retardation plate of the optical communication system according to the embodiment of the present invention will be described in more detail.

It is preferable that the patterned retardation plate is a liquid crystal layer that is formed of a composition including a liquid crystal compound, and it is preferable that each of the phase difference patterns is a pattern described below in which optical axes derived from the liquid crystal compound are aligned.

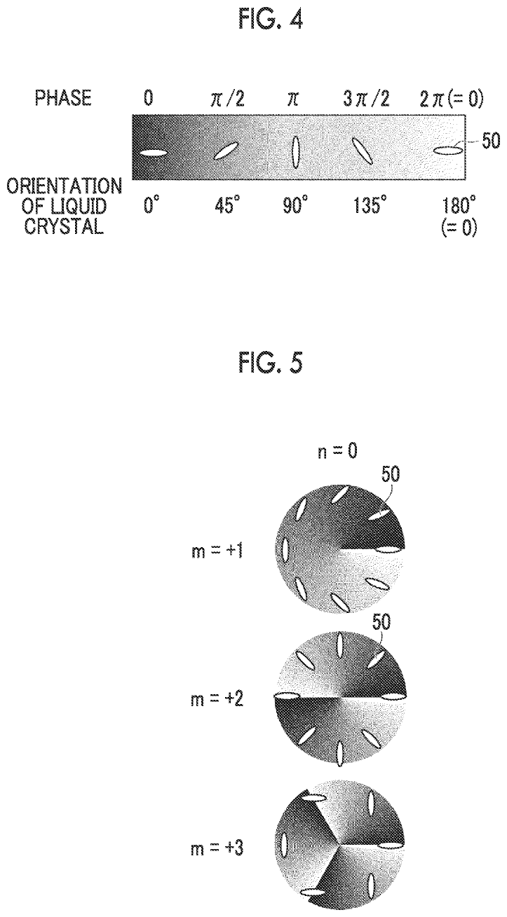

A phase of the phase difference pattern will be described using FIG. 4.

FIG. 4 is a diagram showing a relationship between an orientation of an optical axis in each of fine regions and a normalized phase. FIG. 4 is a diagram showing a phase where an orientation of the optical axis (slow axis) in each of the fine regions in the phase difference pattern is normalized by 0 to 2π and is visualized by gray scale where 0 is represented by black and 2π is represented by white. In addition, reference numeral 50 in FIG. 4 represents a liquid crystal compound (an orientation of the optical axis of the liquid crystal compound).

A state where an optical axis 50 is directed in a left-right direction in the drawing (the angle of the optical axis is 0° in the polar display) as in the leftmost optical axis 50 in FIG. 4 is defined as the phase 0, a state where the optical axis 50 is rotated counterclockwise by 180° as in the rightmost optical axis 50 in the drawing is defined as the phase 2x, and the phase is normalized according to the angle by which the optical axis 50 is rotated counterclockwise. For example, a state where the optical axis 50 is rotated counterclockwise by 45° (the second optical axis 50 from the left) is a phase π/2, a state where the optical axis 50 is rotated counterclockwise by 90° (the third optical axis 50 from the left) is a phase π, and a state where the optical axis 50 is rotated counterclockwise by 135° (the second optical axis 50 from the right) is a phase 3π/2. The change of the optical axis 50 is actually a continuous change, and the optical axis (liquid crystal compound) 50 that is aligned by an angle between the angles of the optical axes 50 in FIG. 4 is present between the optical axes 50. In addition, as can be seen from the drawing, the state of the optical axis in the phase 0 and the state of the optical axis in the phase 2π are the same.

For example, the phases of the phase difference patterns where m=+1 to +3 shown in FIG. 2 will be described using FIG. 5.

In FIG. 5, the phases of the phase difference pattern are represented by gray scale, and the orientations of the optical axes 50 are represented to be superimposed thereon. Basically, the orientation of the optical axis 50 in a fine region of the liquid crystal layer is an orientation of an optical axis derived from the liquid crystal compound. Accordingly, the optical axis 50 in FIG. 5 can also be called the optical axis of the liquid crystal compound. In a case where the liquid crystal compound is a rod-like liquid crystal compound, a major axis of the rod-like liquid crystal compound is the optical axis derived from the liquid crystal compound. In a case where the liquid crystal compound is a disk-like liquid crystal compound, an axis perpendicular to a disc plane of the disk-like liquid crystal compound is the optical axis.

As shown in FIG. 5, in a case where the phase difference pattern where m=+1 is seen counterclockwise in the circumferential direction, the orientation of the optical axis (liquid crystal compound) 50 in the fine region is rotated counterclockwise, and in a case where the phase rotates once from the position of 0 in the circumferential direction, the optical axis 50 rotates half times (180°), that is, the phase gradually changes from 0 to 2π.

In addition, as shown in FIG. 5, in a case where the phase difference pattern where m=+2 is seen counterclockwise in the circumferential direction, the orientation of the optical axis (liquid crystal compound) 50 in the fine region is rotated counterclockwise, and in a case where the phase rotates once from the position of 0 in the circumferential direction, the optical axis 50 rotates once (360°), that is, a phase change from 0 to 2π is repeated twice.

In addition, as shown in FIG. 5, in a case where the phase difference pattern where m=+3 is seen counterclockwise in the circumferential direction, the orientation of the optical axis (liquid crystal compound) 50 in the fine region is rotated counterclockwise, and in a case where the phase rotates once from the position of 0 in the circumferential direction, the optical axis 50 rotates one and a half times (540°), that is, a phase change from 0 to 2π is repeated three times.

In the following description, an example of the phase difference patterns in the patterned retardation plate is represented by phases (gray scale) normalized by 0 to 2.

In the example shown in FIG. 5, the phase difference pattern is configured such that the phase changes in the circumferential direction and is constant in the radial direction, but the present invention is not limited thereto. The phase difference pattern in the patterned retardation plate may include a node where phase is discontinuous in the radial direction.

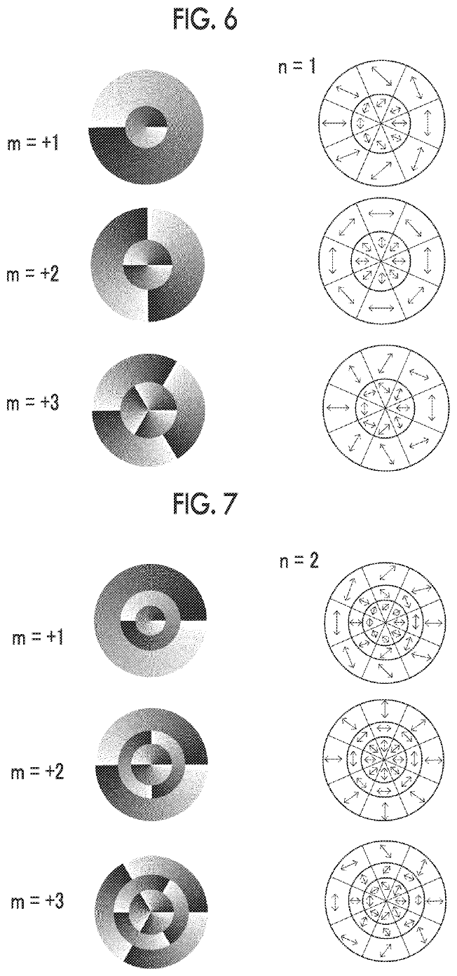

FIG. 6 shows another example of the phase difference patterns in the patterned retardation plate. In FIG. 6, the drawing on the left side is a diagram showing the phase difference patterns using the phases, and the diagram on the right side is a schematic diagram showing slow axis distributions of the phase difference patterns. FIG. 6 shows each of the phase difference patterns in a case where the number of nodes is 1 (n=1) and the order is 1 to 3 (m=+1 to +3).

The diagram where the order m=+1 in FIG. 6 will be described.

As shown on the upper left of FIG. 6, the phase difference pattern where n=1 and m=+1 has a node where the phase is discontinuous in the radial direction. In other words, the phase difference pattern where n=1 and m=+1 includes a circular region and a toric region outside of the circular region, and positions where the phase is 0 are different from each other. Specifically, in the circular region, in a case where the phase difference pattern is seen counterclockwise in the circumferential direction and the phase rotates once from the position of 0 in the circumferential direction, the phase gradually changes from 0 to 2x. That is, the phase change in the circular region is the same as that where no node (n=0) is provided and the order is 1 (m=+1). On the other hand, in the toric region, in a case where the phase difference pattern is seen counterclockwise in the circumferential direction and the phase rotates once from the position of 0 in the circumferential direction, the phase gradually changes from 0 to 2x, but the position where the phase is 0 is shifted by 180° in the circumferential direction from the position where the phase is 0 in the circular region. That is, the phase change in the toric region is the same as that where no node (n=0) is provided and the order is 1 (m=+1).

It can be seen from the schematic diagram of the slow axis distribution of the phase difference pattern where n=1 and m=+1 shown on the upper right in FIG. 6 that the phase, that is, the direction of the slow axis discontinuously changes in the radial direction. The diagram where the order m=+2 in FIG. 6 will be described.

As shown on the middle left of FIG. 6, the phase difference pattern where n=1 and m=+2 has a node where the phase is discontinuous in the radial direction. In other words, the phase difference pattern where n=1 and m=+2 includes a circular region and a toric region outside of the circular region, and positions where the phase is 0 are different from each other. Specifically, in the circular region, in a case where the phase difference pattern is seen counterclockwise in the circumferential direction and the phase rotates once from the position of 0 in the circumferential direction, the phase change from 0 to 2π is repeated twice. That is, the phase change in the circular region is the same as that where no node (n=0) is provided and the order is 2 (m=+2). On the other hand, in the toric region, in a case where the phase difference pattern is seen counterclockwise in the circumferential direction and the phase rotates once from the position of 0 in the circumferential direction, the phase change from 0 to 2π is repeated twice. That is, the phase change in the toric region is also the same as that where no node (n=0) is provided and the order is 2 (m=+2). In addition, in the circular region and the toric region, the positions where the phase is 0 in the circumferential direction are shifted by 90°.

It can be seen from the schematic diagram of the slow axis distribution of the phase difference pattern where n=1 and m=+2 shown on the middle right in FIG. 6 that the phase, that is, the direction of the slow axis discontinuously changes in the radial direction.

The diagram where the order m=+3 in FIG. 6 will be described.

As shown on the lower left of FIG. 6, the phase difference pattern where n=1 and m=+3 has a node where the phase is discontinuous in the radial direction. In other words, the phase difference pattern where n=1 and m=+3 includes a circular region and a toric region outside of the circular region, and positions where the phase is 0 are different from each other. Specifically, in the circular region, in a case where the phase difference pattern is seen counterclockwise in the circumferential direction and the phase rotates once from the position of 0 in the circumferential direction, the phase change from 0 to 2π is repeated three times. That is, the phase change in the circular region is the same as that where no node (n=0) is provided and the order is 3 (m=+3). On the other hand, in the toric region, in a case where the phase difference pattern is seen counterclockwise in the circumferential direction and the phase rotates once from the position of 0 in the circumferential direction, the phase change from 0 to 2π is repeated three times. That is, the phase change in the toric region is also the same as that where no node (n=0) is provided and the order is 3 (m=+3). In addition, in the circular region and the toric region, the positions where the phase is 0 in the circumferential direction are shifted by 60°.

It can be seen from the schematic diagram of the slow axis distribution of the phase difference pattern where n=1 and m=+3 shown on the lower right in FIG. 6 that the phase, that is, the direction of the slow axis discontinuously changes in the radial direction.

This phase difference pattern having the node can form an optical vortex in a different state from a phase difference pattern having the same order but having no node. Accordingly, the patterned retardation plate in the optical communication system according to the present invention may include the phase difference pattern having the node.

Next, an example of phase difference patterns where the number of nodes is 2 (n=2) will be described using FIG. 7. In FIG. 7, the drawing on the left side is a diagram showing the phase difference patterns using the phases, and the diagram on the right side is a schematic diagram showing slow axis distributions of the phase difference patterns. FIG. 7 shows each of the phase difference patterns in a case where the number of nodes is 2 (n=2) and the order is 1 to 3 (m=+1 to +3).

The diagram where the order m=+1 in FIG. 7 will be described.

As shown on the upper left of FIG. 7, the phase difference pattern where n=2 and m=+1 has two nodes where the phase is discontinuous in the radial direction. In other words, the phase difference pattern where n=2 and m=+1 includes a circular region and two toric regions outside of the circular region, and positions where the phase is 0 in adjacent regions are different from each other. Specifically, in the circular region, in a case where the phase difference pattern is seen counterclockwise in the circumferential direction and the phase rotates once from the position of 0 in the circumferential direction, the phase gradually changes from 0 to 2π. That is, the phase change in the circular region is the same as that where no node (n=0) is provided and the order is 1 (m=+1). On the other hand, in the first toric region in contact with the circular region, in a case where the phase difference pattern is seen counterclockwise in the circumferential direction and the phase rotates once from the position of 0 in the circumferential direction, the phase gradually changes from 0 to 2x. That is, the phase change in the first toric region is the same as that where no node (n=0) is provided and the order is 1 (m=+1). In addition, in the circular region and the first toric region, the positions where the phase is 0 in the circumferential direction are shifted by 180°. In addition, in the second toric region in contact with the outside of the first toric region, in a case where the phase difference pattern is seen counterclockwise in the circumferential direction and the phase rotates once from the position of 0 in the circumferential direction, the phase gradually changes from 0 to 2π. That is, the phase change in the second toric region is the same as that where no node (n=0) is provided and the order is 1 (m=+1). In addition, in the first toric region and the second toric region, the positions where the phase is 0 in the circumferential direction are shifted by 180°. In addition, in the circular region and the second toric region that are not in contact with each other, the positions where the phase is 0 in the circumferential direction match with each other.

It can be seen from the schematic diagram of the slow axis distribution of the phase difference pattern where n=2 and m=+1 shown on the upper right in FIG. 7 that the phase, that is, the direction of the slow axis discontinuously changes twice in the radial direction.

The diagram where the order m=+2 in FIG. 7 will be described.

As shown on the middle left of FIG. 7, the phase difference pattern where n=2 and m=+2 has two nodes where the phase is discontinuous in the radial direction. In other words, the phase difference pattern where n=2 and m=+2 includes a circular region and two toric regions outside of the circular region, and positions where the phase is 0 in adjacent regions are different from each other. Specifically, in the circular region, in a case where the phase difference pattern is seen counterclockwise in the circumferential direction and the phase rotates once from the position of 0 in the circumferential direction, the phase change from 0 to 2π is repeated twice. That is, the phase change in the circular region is the same as that where no node (n=0) is provided and the order is 2 (m=+2). On the other hand, in the first toric region in contact with the circular region, in a case where the phase difference pattern is seen counterclockwise in the circumferential direction and the phase rotates once from the position of 0 in the circumferential direction, the phase change from 0 to 2π is repeated twice. That is, the phase change in the first toric region is the same as that where no node (n=0) is provided and the order is 2 (m=+2). In addition, in the circular region and the first toric region, the positions where the phase is 0 in the circumferential direction are shifted by 90°. In addition, in the second toric region in contact with the outside of the first toric region, in a case where the phase difference pattern is seen counterclockwise in the circumferential direction and the phase rotates once from the position of 0 in the circumferential direction, the phase change from 0 to 2π is repeated twice. That is, the phase change in the second toric region is the same as that where no node (n=0) is provided and the order is 2 (m=+2). In addition, in the first toric region and the second toric region, the positions where the phase is 0 in the circumferential direction are shifted by 90°. In addition, in the circular region and the second toric region that are not in contact with each other, the positions where the phase is 0 in the circumferential direction match with each other.

It can be seen from the schematic diagram of the slow axis distribution of the phase difference pattern where n=2 and m=+2 shown on the middle right in FIG. 7 that the phase, that is, the direction of the slow axis discontinuously changes twice in the radial direction.

The diagram where the order m=+3 in FIG. 7 will be described.

As shown on the lower left of FIG. 7, the phase difference pattern where n=2 and m=+3 has two nodes where the phase is discontinuous in the radial direction. In other words, the phase difference pattern where n=2 and m=+3 includes a circular region and two toric regions outside of the circular region, and positions where the phase is 0 in adjacent regions are different from each other. Specifically, in the circular region, in a case where the phase difference pattern is seen counterclockwise in the circumferential direction and the phase rotates once from the position of 0 in the circumferential direction, the phase change from 0 to 2π is repeated three times. That is, the phase change in the circular region is the same as that where no node (n=0) is provided and the order is 3 (m=+3). On the other hand, in the first toric region in contact with the circular region, in a case where the phase difference pattern is seen counterclockwise in the circumferential direction and the phase rotates once from the position of 0 in the circumferential direction, the phase change from 0 to 2π is repeated three times. That is, the phase change in the first toric region is the same as that where no node (n=0) is provided and the order is 3 (m=+3). In addition, in the circular region and the first toric region, the positions where the phase is 0 in the circumferential direction are shifted by 60°. In addition, in the second toric region in contact with the outside of the first toric region, in a case where the phase difference pattern is seen counterclockwise in the circumferential direction and the phase rotates once from the position of 0 in the circumferential direction, the phase change from 0 to 2π is repeated three times. That is, the phase change in the second toric region is the same as that where no node (n=0) is provided and the order is 3 (m=+3). In addition, in the first toric region and the second toric region, the positions where the phase is 0 in the circumferential direction are shifted by 60°. In addition, in the circular region and the second toric region that are not in contact with each other, the positions where the phase is 0 in the circumferential direction match with each other.

It can be seen from the schematic diagram of the slow axis distribution of the phase difference pattern where n=2 and m=+3 shown on the lower right in FIG. 7 that the phase, that is, the direction of the slow axis discontinuously changes twice in the radial direction.

The phase difference patterns that are different in the number of nodes and/or the order can form a plurality of optical vortices in different states. Accordingly, the patterned retardation plate in the optical communication system according to the present invention may include the phase difference patterns that are different in the number of nodes or the order.

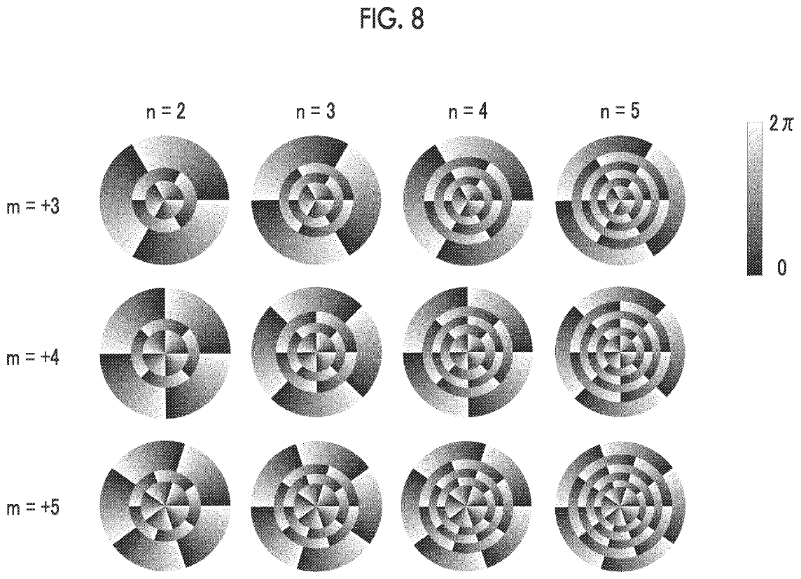

The number of nodes is not limited to 0 to 2 and may be 3 or more. In addition, as described above, the order is not also limited to 0 to +3 and may be +4 or more or may be −4 or less. For example, FIG. 8 shows phase difference patterns where n=2 to 5 and m=+3 to +5. The phase difference patterns can form optical vortices that are different from each other.

### [Patterned Retardation Plate]

A patterned retardation plate according to an embodiment of the present invention includes a plurality of phase difference patterns that convert incident polarized light into optical vortices, in which the plurality of phase difference patterns that are different in the order are provided in the same plane.

The phase difference patterns in the patterned retardation plate are as described above, and the phase difference patterns that are different in the number of nodes and/or the order are provided in the same plane in the patterned retardation plate.

The arrangement of the phase difference patterns in the patterned retardation plate is not particularly limited. For example, four types of phase difference patterns where the number of nodes n=0 and the order m=0 to +3 can be arranged in one direction in order of the order.

Next, a method of forming the phase difference patterns will be described.

In the present invention, the method of forming the phase difference patterns is not particularly limited.

In a case where the patterned retardation plate is a liquid crystal layer obtained by aligning a liquid crystal compound to a predetermined alignment state, the patterned retardation plate can be formed by applying a liquid crystal composition including the liquid crystal compound to an alignment film for aligning the liquid crystal compound in a predetermined phase difference pattern, forming a liquid crystal phase where an orientation of an optical axis derived from the liquid crystal compound is aligned in the phase difference pattern, and immobilizing the liquid crystal phase in a layer shape.

In addition, in the present invention, the liquid crystal layer may be formed by application of multiple layers. The application of the multiple layers refers to a method of forming the liquid crystal layer by repeating the following processes until a desired thickness is obtained, the processes including: forming a first liquid crystal immobilized layer by applying the liquid crystal composition for forming the first layer to the alignment film, heating the liquid crystal composition, cooling the liquid crystal composition, and irradiating the liquid crystal composition with ultraviolet light for curing; and forming a second or subsequent liquid crystal immobilized layer by applying the liquid crystal composition for forming the second or subsequent layer to the formed liquid crystal immobilized layer, heating the liquid crystal composition, cooling the liquid crystal composition, and irradiating the liquid crystal composition with ultraviolet light for curing as described above.

### (Alignment Film)

The alignment film is an alignment film for aligning the liquid crystal compound to a predetermined phase difference pattern during the formation of the liquid crystal layer.

The alignment film can be suitably used as a so-called photo-alignment film obtained by irradiating a photo-alignment material with polarized light or non-polarized light. That is, in the present invention, for example, a photo-alignment film that is formed by applying a photo-alignment material to a support is suitably used as the alignment film.

The irradiation of polarized light can be performed in a direction perpendicular or oblique to the photo-alignment film, and the irradiation of non-polarized light can be performed in a direction oblique to the photo-alignment film.

Preferable examples of the photo-alignment material used in the alignment film that can be used in the present invention include: an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking polyester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A.

Among these, an azo compound, a photocrosslinking polyimide, a photocrosslinking polyamide, a photocrosslinking polyester, a cinnamate compound, or a chalcone compound is suitably used.

A thickness of the alignment film is not particularly limited. The thickness with which a required alignment function can be obtained may be appropriately set depending on the material for forming the alignment film.

The thickness of the alignment film is preferably 0.01 to 5 μm and more preferably 0.05 to 2 μm.

In the present invention, examples of a suitable exposure method of the alignment film for forming the alignment pattern include a method of exposing the alignment film using a direct drawing method and a method of performing polarization exposure multiple times using masks having different exposure patterns.

In the direct drawing method, a support including an alignment film is disposed on an XY stage, a linearly polarized light beam passes through a λ/2 plate to focus the beam on the alignment film, moving the XY stage to scan the focusing position, and rotating the λ/2 plate to convert the polarization direction of the linearly polarized light to any direction. As a result, a desired alignment pattern is drawn on the alignment film.

The rotation of the λ/2 plate and the movement of the XY stage are controlled by, for example, a computer to associate a position on the surface of the alignment film where the light is focused and the polarization direction of the light with each other. As a result, a desired alignment pattern can be formed on the alignment film.

The intensity, exposure time, and the like of the light to be irradiated may be appropriately set depending on the material for forming the alignment film and the like.

The exposure amount per unit area can be adjusted by adjusting the intensity of the light to be irradiated and a scanning speed. From the viewpoint of performing sufficient exposure to apply aligning properties to the alignment film, the exposure amount is preferably 100 mJ/m² or more and more preferably 150 mJ/m² or more. In addition, from the viewpoint of preventing a decrease in aligning properties caused by excessive irradiation, the exposure amount is preferably 5 J/m² or less and more preferably 3 J/m² or less.

In addition, the spot diameter of the focused light beam on the alignment film may be a size where a desired alignment pattern can be applied to the alignment film.

Hereinafter, the method (hereinafter, also referred to as multiple polarization exposure method) of performing polarization exposure on the alignment film multiple times using masks having different exposure patterns will be described.

The multiple polarization exposure method is an exposure method including a step of performing polarization exposure on the photo-alignment film, for example, three times, in which in the three times of polarization exposure, irradiation light amount patterns are different from each other, and polarization directions of linearly polarized light to be irradiated are different from each other.

An example of the multiple polarization exposure method will be described using FIGS. 9 to 11.

The upper diagram of FIG. 9 is a diagram conceptually showing the mask used for the first polarization exposure, and the lower diagram of FIG. 9 is an arrow showing the polarization direction of the linearly polarized light to be irradiated in the first polarization exposure.

In addition, the upper diagram of FIG. 10 is a diagram conceptually showing the mask used for the second polarization exposure, and the lower diagram of FIG. 10 is an arrow showing the polarization direction of the linearly polarized light to be irradiated in the second polarization exposure.

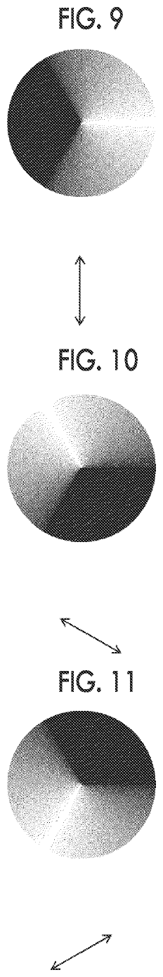

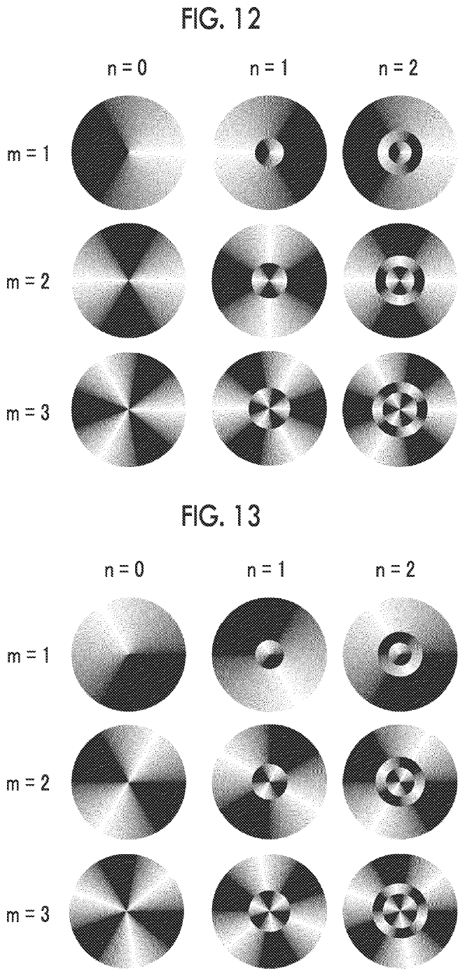

In addition, the upper diagram of FIG. 11 is a diagram conceptually showing the mask used for the third polarization exposure, and the lower diagram of FIG. 11 is an arrow showing the polarization direction of the linearly polarized light to be irradiated in the third polarization exposure.

In the upper drawings of FIGS. 9 to 11, a transmittance of the mask used for the polarization exposure is represented by gray scale, in which a region where the transmittance is high (for example, 100%) is represented by white and a region where the transmittance is low (for example, 0%) is represented by black.

As shown in FIGS. 9 to 11, all of the masks used for the first to third polarization exposures have a transmittance pattern in which the transmittance is the lowest at the position of 180° in the circumferential direction from the position where the transmittance is the highest and the transmittance gradually changes between the positions. In addition, in the masks used for the first to third polarization exposures, the positions where the transmittance is the highest are shifted from each other in the circumferential direction. Specifically, the position of the mask of the second polarization exposure where the transmittance is the highest is shifted by 120° in the circumferential direction from the position of the mask of the first polarization exposure where the transmittance is the highest. In addition, the position of the mask of the third polarization exposure where the transmittance is the highest is shifted by 240° in the circumferential direction from the position of the mask of the first polarization exposure where the transmittance is the highest (by 120° from that of the mask of the second polarization exposure).

In addition, as shown in FIG. 9, the polarization direction of the linearly polarized light used for the first polarization exposure is orthogonal to a direction (the right direction in the drawing) where the transmittance of the mask of the first polarization exposure is the highest.

In addition, as shown in FIGS. 9 and 10, the polarization direction of the linearly polarized light used for the second polarization exposure is shifted by 60° counterclockwise from the polarization direction of the linearly polarized light used for the first polarization exposure.

In addition, as shown in FIGS. 9 and 11, the polarization direction of the lincarly polarized light used for the third polarization exposure is shifted by)60° (−60° clockwise from the polarization direction of the linearly polarized light used for the first polarization exposure. That is, the polarization direction of the linearly polarized light used for the third polarization exposure is shifted by)120° (−120° clockwise from the polarization direction of the linearly polarized light used for the second polarization exposure.

In a case where the polarization exposure is performed multiple times using linearly polarized light components having different polarization directions, an averaged orientation restriction force corresponding to the exposure amount is generated. Therefore, by performing the polarization exposure multiple times using the masks and the linearly polarized light, a ratio between the exposure amounts of the polarization exposures changes depending on the in-plane positions of the alignment film, and the direction of the orientation restriction force changes depending on the positions of the alignment film.

For example, in a case where an azo-based photo-alignment film is used, the orientation restriction force is generated in a direction orthogonal to the polarization direction of the irradiated linearly polarized light. Therefore, at a position in a direction (right side in the drawing) in which the orientation is 0°, the transmittance of the mask of the first polarization exposure is high, and the transmittances of the masks of the second and third polarization exposures are lower than the transmittance of the mask of the first polarization exposure and are substantially the same as each other. Therefore, in a case where the polarization directions of the first to third polarization exposures are caused to overlap each other, the alignment film is exposed to the linearly polarized light in the up-down direction in the drawing, and the orientation restriction force is generated in a direction (left-right direction) orthogonal to the up-down direction. Therefore, at a position in a direction (left side in the drawing) in which the orientation is 180°, the transmittance of the mask of the first polarization exposure is low, and the transmittances of the masks of the second and third polarization exposures are higher than the transmittance of the mask of the first polarization exposure and are substantially the same as each other. Therefore, in a case where the polarization directions of the first to third polarization exposures are caused to overlap each other, the alignment film is exposed to the linearly polarized light in the left-right direction in the drawing, and the orientation restriction force is generated in the up-down direction in the drawing.

This way, the direction of the orientation restriction force changes depending on the in-plane positions of the alignment film, and an alignment pattern for forming the phase difference pattern where an azimuthal angle of a slow axis changes in a case where the azimuthal angle rotates once around one point can be formed.

In the example shown in FIGS. 9 to 11, an alignment pattern for forming the phase difference pattern where the order m=+1 shown in FIG. 2 can be formed on the alignment film.

The order of the polarization exposures is not limited to the above-described configuration, and in a case where polarization exposure is performed three times using masks and different polarized light components, a desired alignment pattern can be obtained even in an order different from the above-described order.

In addition, depending on the type of the photo-alignment film, the polarization direction of the polarization exposure and the alignment direction of the liquid crystal may be the same. In this case, by appropriately rotating the exposure mask patterns by the same angle correspondingly, a desired alignment pattern can be obtained.

In addition, in the above-described configuration, the polarization exposure is performed three times. However, as long as a desired alignment pattern can be obtained, the present invention is not limited to this configuration, and polarization exposure may be performed four or more times.

In addition, the distribution of the transmittances of the masks used for the polarization exposures and the polarization directions of the linearly polarized light components to be irradiated are limited to the above-described example as long as a desired alignment pattern can be obtained. The distribution of the transmittances of the masks used for the polarization exposures and the polarization directions of the linearly polarized light components to be irradiated may be appropriately set according to a desired alignment pattern.

FIGS. 12 to 14 are diagrams conceptually showing the transmittance of a mask for forming an alignment pattern for forming each of phase difference patterns where the number of nodes n=0 to 2 and the order m=+1 to +3.

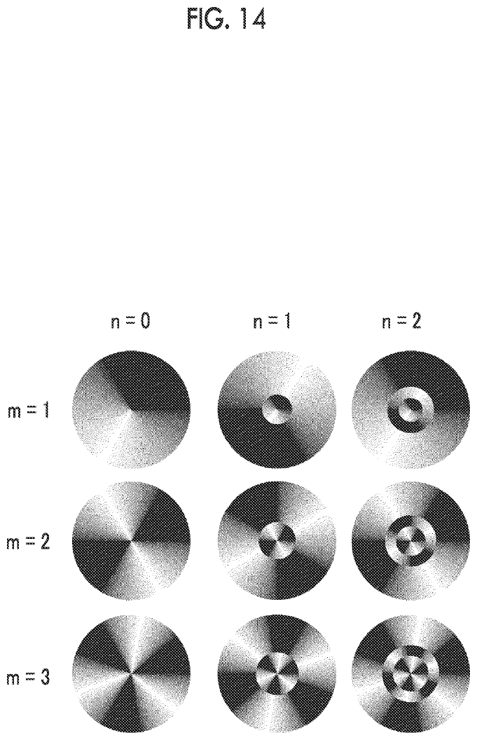

In a case where the mask illustrated in FIG. 12 is used, linearly polarized light where the polarization direction is the up-down direction with respect to the mask shown in the drawing is used (refer to FIG. 9), in a case where the mask illustrated in FIG. 13 is used, linearly polarized light where the polarization direction is tilted by 60° counterclockwise with respect to the up-down direction of the mask shown in the drawing is used (refer to FIG. 10), and in a case where the mask illustrated in FIG. 14 is used, linearly polarized light where the polarization direction is tilted by 60° (−60° clockwise with respect to the up-down direction of the mask shown in the drawing is used (refer to FIG. 11).

By performing polarization exposure three times using the masks shown in FIGS. 12 to 14, the phase difference patterns shown in FIGS. 5 to 7 can be formed, respectively.

Here, the formation of the alignment patterns using the multiple polarization exposure method is preferable from the viewpoint that the masks having different transmittance patterns can be arranged in the in-plane direction to perform the polarization exposure using the same linearly polarized light such that different alignment patterns can be easily formed in the same plane of one alignment film.

For example, in a case where alignment patterns corresponding to the phase difference patterns where the number of nodes n=0 and the order m=+1 to +3 are formed on one alignment film, the first polarization exposure is performed using the mask where the transmittance patterns corresponding to the number of nodes n=0 and the order m=+1 to +3 shown in FIGS. 9 and 12 are arranged in a plane, the second polarization exposure is performed using the mask where the transmittance patterns corresponding to the number of nodes n=0 and the order m=+1 to +3 shown in FIGS. 10 and 13 are arranged in a plane, and the third polarization exposure is performed using the mask where the transmittance patterns corresponding to the number of nodes n=0 and the order m=+1 to +3 shown in FIGS. 11 and 14 are arranged in a plane. As a result, the alignment patterns corresponding to the phase difference patterns where the number of nodes n=0 and the order m=+1 to +3 can be formed on one alignment film. By forming the liquid crystal layer on the alignment film having the plurality of alignment patterns, the patterned retardation plate in which the plurality of phase difference patterns that are different in the order are provided in the same plane can be prepared.

### (Liquid Crystal Layer)

The liquid crystal layer is formed on the surface of the alignment film.

As described above, the liquid crystal layer is obtained by immobilizing the liquid crystal phase where the liquid crystal compound is aligned, and has the phase difference patterns.

### <<Method of Forming Liquid Crystal Layer>>

The liquid crystal layer can be formed by immobilizing the liquid crystal phase where the liquid crystal compound is aligned in the phase difference patterns.

The structure in which the liquid crystal phase is immobilized may be a structure in which the alignment of the liquid crystal compound as a liquid crystal phase is immobilized. Typically, the structure in which the liquid crystal phase is immobilized is preferably a structure which is obtained by aligning the polymerizable liquid crystal compound in the phase difference pattern, polymerizing and curing the polymerizable liquid crystal compound with ultraviolet irradiation, heating, or the like to form a layer having no fluidity, and concurrently changing the state of the polymerizable liquid crystal compound into a state where the alignment state is not changed by an external field or an external force.

The structure in which the liquid crystal phase is immobilized is not particularly limited as long as the optical characteristics of the liquid crystal phase are maintained, and the liquid crystal compound in the liquid crystal layer does not necessarily exhibit liquid crystallinity. For example, the molecular weight of the polymerizable liquid crystal compound may be increased by a curing reaction such that the liquid crystallinity thereof is lost.

Examples of a material used for forming the liquid crystal layer obtained by immobilizing a liquid crystal phase include a liquid crystal composition including a liquid crystal compound. It is preferable that the liquid crystal compound is a polymerizable liquid crystal compound.

In addition, the liquid crystal composition used for forming the liquid crystal layer may further include a surfactant and a polymerization initiator.

### Polymerizable Liquid Crystal Compound

The polymerizable liquid crystal compound may be a rod-like liquid crystal compound or a disk-like liquid crystal compound.

Examples of the polymerizable liquid crystal compound for forming the rod-like liquid crystal layer include a rod-like nematic liquid crystal compound. As the rod-like nematic liquid crystal compound, an azomethine compound, an azoxy compound, a cyanobiphenyl compound, a cyanophenyl ester compound, a benzoate compound, a phenyl cyclohexanecarboxylate compound, a cyanophenylcyclohexane compound, a cyano-substituted phenylpyrimidine compound, an alkoxy-substituted phenylpyrimidine compound, a phenyldioxane compound, a tolan compound, or an alkenylcyclohexylbenzonitrile compound is preferably used. Not only a low-molecular-weight liquid crystal compound but also a polymer liquid crystal compound can be used.

It is preferable that the alignment of the rod-like liquid crystal compound is immobilized by polymerization. Examples of the polymerizable rod-like liquid crystal compound include compounds described in Makromol. Chem., (1989), Vol. 190, p. 2255, Advanced Materials (1993), Vol. 5, p. 107, U.S. Pat. Nos. 4,683,327A, 5,622,648A, 5,770,107A, WO95/22586A, WO95/24455A, WO97/00600A, WO98/23580A, WO98/52905A, JP1989-272551A (JP-H1-272551A), JP1994-16616A (JP-H6-16616A), JP1995-110469A (JP-H7-110469A), JP1999-80081A (JP-H11-80081A), and JP2001-64627. Further, as the rod-like liquid crystal compound, for example, compounds described in JP1999-513019A (JP-H11-513019A) and JP2007-279688A can also be preferably used. In addition, two or more kinds of polymerizable liquid crystal compounds may be used in combination. In a case where two or more polymerizable liquid crystal compounds are used in combination, the alignment temperature can be decreased.

Examples of the polymerizable group include an unsaturated polymerizable group, an epoxy group, and an aziridinyl group. Among these, an unsaturated polymerizable group is preferable, and an ethylenically unsaturated polymerizable group is more preferable. The polymerizable group can be introduced into the molecules of the liquid crystal compound using various methods. The number of polymerizable groups in the polymerizable liquid crystal compound is preferably 1 to 6 and more preferably 1 to 3.

In addition, as a polymerizable liquid crystal compound other than the above-described examples, for example, a cyclic organopolysiloxane compound having a cholesteric phase described in JP1982-165480A (JP-S57-165480A) can be used. Further, as the above-described polymer liquid crystal compound, for example, a polymer in which a liquid crystal mesogenic group is introduced into a main chain, a side chain, or both a main chain and a side chain, a polymer cholesteric liquid crystal in which a cholesteryl group is introduced into a side chain, a liquid crystal polymer described in JP1997-133810A (JP-H9-133810A), and a liquid crystal polymer described in JP1999-293252A (JP-H11-293252A) can be used.

### Disk-Like Liquid Crystal Compound

As the disk-like liquid crystal compound, for example, compounds described in JP2007-108732A and JP2010-244038A can be preferably used.

In a case where the disk-like liquid crystal compound is used in the liquid crystal layer, the liquid crystal compound rises in the thickness direction in the liquid crystal layer, and the optical axis derived from the liquid crystal compound is defined as an axis perpendicular to a disc plane, that is, a so-called fast axis.

In addition, the addition amount of the polymerizable liquid crystal compound in the liquid crystal composition is preferably 75 to 99.9 mass %, more preferably 80 to 99 mass %, and still more preferably 85 to 90 mass % with respect to the solid content mass (mass excluding a solvent) of the liquid crystal composition.

In order to obtain a high diffraction efficiency, it is preferable that a liquid crystal compound having high refractive index anisotropy Δn is used as the liquid crystal compound.

### Surfactant

The liquid crystal composition used for forming the liquid crystal layer may include a surfactant.

The surfactant is preferably a compound which can function as an alignment control agent contributing to the alignment of the liquid crystal compound in a stable or rapid manner. Examples of the surfactant include a silicone-based surfactant and a fluorine-based surfactant. Among these, a fluorine-based surfactant is preferable.

Specific examples of the surfactant include compounds described in paragraphs “0082” to “0090” of JP2014-119605A, compounds described in paragraphs “0031” to “0034” of JP2012-203237A, exemplary compounds described in paragraphs “0092” and “0093” of JP2005-99248A, exemplary compounds described in paragraphs “0076” to “0078” and paragraphs “0082” to “0085” of JP2002-129162A, and fluorine (meth)acrylate polymers described in paragraphs “0018” to “0043” of JP2007-272185A.

The surfactants may be used alone or in combination of two or more kinds.

As the fluorine-based surfactant, a compound described in paragraphs “0082” to “0090” of JP2014-119605A is preferable.

The addition amount of the surfactant in the liquid crystal composition is preferably 0.01 to 10 mass %, more preferably 0.01 to 5 mass %, and still more preferably 0.02 to 2 mass % with respect to the total mass of the liquid crystal compound.

### Polymerization Initiator

In a case where the liquid crystal composition includes a polymerizable compound, it is preferable that the liquid crystal composition includes a polymerization initiator. In an aspect where a polymerization reaction progresses with ultraviolet irradiation, it is preferable that the polymerization initiator to be used is a photopolymerization initiator which initiates a polymerization reaction with ultraviolet irradiation.

Examples of the photopolymerization initiator include an α-carbonyl compound (described in U.S. Pat. Nos. 2,367,661A and 2,367,670A), an acyloin ether (described in U.S. Pat. No. 2,448,828A), an α-hydrocarbon-substituted aromatic acyloin compound (described in U.S. Pat. No. 2,722,512A), a polynuclear quinone compound (described in U.S. Pat. Nos. 3,046,127A and 2,951,758A), a combination of a triarylimidazole dimer and p-aminophenyl ketone (described in U.S. Pat. No. 3,549,367A), an acridine compound and a phenazine compound (described in JP1985-105667A (JP-S60-105667A) and U.S. Pat. No. 4,239,850A), and an oxadiazole compound (described in U.S. Pat. No. 4,212,970A).

The content of the photopolymerization initiator in the liquid crystal composition is preferably 0.1 to 20 mass % and more preferably 0.5 to 12 mass % with respect to the content of the liquid crystal compound.

### Crosslinking Agent

In order to improve the film hardness after curing and to improve durability, the liquid crystal composition may optionally include a crosslinking agent. As the crosslinking agent, a curing agent which can perform curing with ultraviolet light, heat, moisture, or the like can be suitably used.

The crosslinking agent is not particularly limited and can be appropriately selected depending on the purpose. Examples of the crosslinking agent include: a polyfunctional acrylate compound such as trimethylol propane tri(meth)acrylate or pentaerythritol tri(meth)acrylate; an epoxy compound such as glycidyl (meth)acrylate or ethylene glycol diglycidyl ether; an aziridine compound such as 2,2-bis hydroxymethyl butanol-tris[3-(1-aziridinyl)propionate] 4,4-bis(ethylenciminocarbonylamino)diphenylmethane; an isocyanate compound such as hexamethylene diisocyanate or a biuret type isocyanate; a polyoxazoline compound having an oxazoline group at a side chain thereof; and an alkoxysilane compound such as vinyl trimethoxysilane or N-(2-aminoethyl)-3-aminopropyltrimethoxysilane. In addition, depending on the reactivity of the crosslinking agent, a well-known catalyst can be used, and not only film hardness and durability but also productivity can be improved. The crosslinking agents may be used alone or in combination of two or more kinds.

The content of the crosslinking agent is preferably 3% to 20 mass % and more preferably 5% to 15 mass % with respect to the solid content mass of the liquid crystal composition. In a case where the content of the crosslinking agent is in the above-described range, an effect of improving a crosslinking density can be easily obtained, and the stability of a liquid crystal phase is further improved.

### Other Additives

Optionally, a polymerization inhibitor, an antioxidant, an ultraviolet absorber, a light stabilizer, a coloring material, metal oxide fine particles, or the like can be added to the liquid crystal composition in a range where optical performance and the like do not deteriorate.

In a case where the liquid crystal layer is formed, it is preferable that the liquid crystal composition is used as liquid.

The liquid crystal composition may include a solvent. The solvent is not particularly limited and can be appropriately selected depending on the purpose. An organic solvent is preferable.

The organic solvent is not particularly limited and can be appropriately selected depending on the purpose. Examples of the organic solvent include a ketone, an alkyl halide, an amide, a sulfoxide, a heterocyclic compound, a hydrocarbon, an ester, and an ether. The organic solvents may be used alone or in combination of two or more kinds. Among these, a ketone is preferable in consideration of an environmental burden.

In a case where the liquid crystal layer is formed, it is preferable that the liquid crystal layer is formed by applying the liquid crystal composition to a surface where the liquid crystal layer is to be formed, aligning the liquid crystal compound to a state where the liquid crystal phase is aligned in the predetermined liquid crystal alignment pattern, and curing the liquid crystal compound.

That is, in a case where the liquid crystal layer is formed on the alignment film, it is preferable that the liquid crystal layer obtained by immobilizing a liquid crystal phase is formed by applying the liquid crystal composition to the alignment film, aligning the liquid crystal compound in the predetermined liquid crystal alignment pattern, and curing the liquid crystal compound.

For the application of the liquid crystal composition, a printing method such as ink jet or scroll printing or a well-known method such as spin coating, bar coating, or spray coating capable of uniformly applying liquid to a sheet-shaped material can be used.

The applied liquid crystal composition is optionally dried and/or heated and then is cured to form the liquid crystal layer. In the drying and/or heating step, the liquid crystal compound in the liquid crystal composition only has to be aligned in the predetermined liquid crystal alignment pattern. In the case of heating, the heating temperature is preferably 200° C. or lower and more preferably 130° C. or lower.

The aligned liquid crystal compound is optionally further polymerized. Regarding the polymerization, thermal polymerization or photopolymerization using light irradiation may be performed, and photopolymerization is preferable. Regarding the light irradiation, ultraviolet light is preferably used. The irradiation energy is preferably 20 mJ/cm² to 50 J/cm² and more preferably 50 to 1500 mJ/cm². In order to promote a photopolymerization reaction, light irradiation may be performed under heating conditions or in a nitrogen atmosphere. The wavelength of irradiated ultraviolet light is preferably 250 nm to 430 nm.

A thickness of the liquid crystal layer is not particularly limited and may be appropriately set depending on the use of the liquid crystal layer, the material for forming the liquid crystal layer, and the like.

It is preferable that the value of an in-plane retardation (Re) in the fine region of the liquid crystal layer is half of a wavelength of light (for example, near infrared light) emitted from the light source of the optical communication system, that is, is λ/2. The in-plane retardation is calculated from the product of a difference Δn in refractive index generated by refractive index anisotropy of the region and the thickness of the liquid crystal layer. Here, the difference in refractive index generated by refractive index anisotropy of the region in the liquid crystal layer is defined by a difference between a refractive index of a direction of an in-plane slow axis of the region and a refractive index of a direction orthogonal to the direction of the slow axis. That is, the difference Δn in refractive index generated by refractive index anisotropy of the region R is the same as a difference between a refractive index of the liquid crystal compound in the direction of the optical axis and a refractive index of the liquid crystal compound in a direction perpendicular to the optical axis in a plane of the region. That is, the difference Δn in refractive index is the same as the difference in refractive index of the liquid crystal compound.

Although the liquid crystal layer functions as a so-called λ/2 plate, the present invention includes an aspect where a laminate including the support and the alignment film that are integrated functions as a λ/2 plate.

Hereinabove, the optical communication system and the patterned retardation plate according to the embodiment of the present invention have been described in detail. However, the present invention is not limited to the above-described examples, and various improvements and modifications can be made within a range not departing from the scope of the present invention.

### EXAMPLES

Hereinafter, the characteristics of the present invention will be described in detail using examples.

Materials, chemicals, used amounts, material amounts, ratios, treatment details, treatment procedures, and the like shown in the following examples can be appropriately changed within a range not departing from the scope of the present invention. Accordingly, the scope of the present invention is not limited to the following specific examples.

### Example 1

### <Preparation of Liquid Crystal Layer>

### (Support)

A flat plate-shaped glass substrate was prepared as the support.

### (Formation of Alignment Film)

The following coating liquid for forming an alignment film was applied to the support by spin coating. The support on which the coating film of the coating liquid for forming an alignment film was formed was dried using a hot plate at 60° ° C. for 60 seconds. As a result, an alignment film was formed.

Coating Liquid for forming Alignment Film

| | | |
|---|---|---|
| Material A for photo-alignment | 1.00 | part by mass |
| Water | 16.00 | parts by mass |
| Butoxyethanol | 42.00 | parts by mass |
| Propylene glycol monomethyl | 42.00 | parts by mass |
| ether | | |

Material A for Photo-Alignment

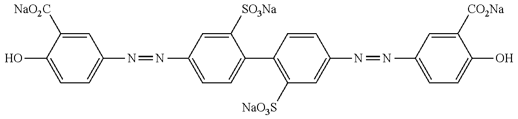

### (Exposure of Alignment Film)

By performing polarization exposure on the alignment film three times as described below, alignment patterns were formed on the alignment film.

### [First Polarization Exposure]

Using a mask where the transmittance patterns where n=0 to 2 and m=+1 to +3 shown in FIG. 12 were arranged in the state shown in FIG. 12, the first polarization exposure was performed by adjusting an angle of a wire grid polarizing plate such that a polarization direction with respect to the mask was the direction shown in FIG. 9. The wire grid was disposed in front of a light source. As the light source, a laser light source having a wavelength of 355 nm was used. The exposure amount of light passed through the wire grid was 100 mJ/m².

### [Second Polarization Exposure]

The second polarization exposure was performed using the same method as that of the first polarization exposure, except that a mask where the transmittance patterns where n=0 to 2 and m=+1 to +3 shown in FIG. 13 were arranged in the state shown in FIG. 13 was used and a polarization direction with respect to the mask was the direction shown in FIG. 10.

### [Third Polarization Exposure]

The third polarization exposure was performed using the same method as that of the first polarization exposure, except that a mask where the transmittance patterns where n=0 to 2 and m=+1 to +3 shown in FIG. 14 were arranged in the state shown in FIG. 14 was used and a polarization direction with respect to the mask was the direction shown in FIG. 11.

As a result, an alignment film P-1 having the plurality of alignment pattern was formed.

### (Formation of Liquid Crystal Layer)

As the liquid crystal composition forming the liquid crystal layer, the following composition A-1 was prepared.

### Composition A-1

| | | |
|---|---|---|
| Liquid crystal compound L-1 | 100.00 | parts by mass |
| Polymerization initiator (IRGACURE OXE01, manufactured by BASF SE) | 1.00 | part by mass |
| Leveling agent T-1 | 0.08 | parts by mass |
| Methyl ethyl ketone | 1050.00 | parts by mass |

Liquid crystal compound L-1 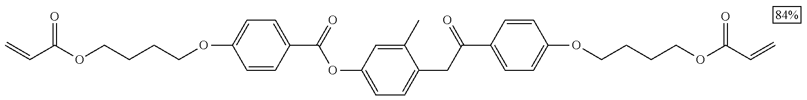 [SMILES: C=CC(=O)OCCCCOc1ccc(C(=O)Cc2ccc(OC(=O)c3ccc(OCCCCOC(=O)C=C)cc3)cc2C)cc1] 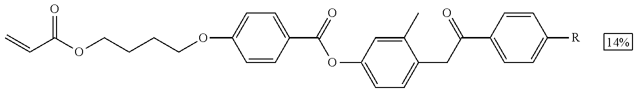 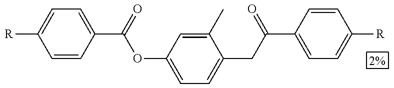 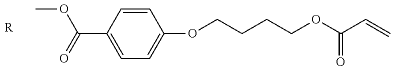
Leveling Agent T-1

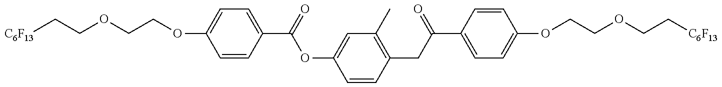

The liquid crystal layer was formed by applying multiple layers of the composition A-1 to the alignment film P-1. The application of the multiple layers refers to repetition of the following processes including: preparing a first liquid crystal immobilized layer by applying the composition A-1 for forming the first layer to the alignment film, heating the composition A-1, and irradiating the composition A-1 with ultraviolet light for curing; and preparing a second or subsequent liquid crystal immobilized layer by applying the composition A-1 for forming the second or subsequent layer to the formed liquid crystal immobilized layer, heating the composition A-1, and irradiating the composition A-1 with ultraviolet light for curing as described above. Even in a case where the liquid crystal layer was formed by the application of the multiple layers such that the total thickness of the liquid crystal layer was large, the alignment direction of the alignment film was reflected from a lower surface of the liquid crystal layer to an upper surface thereof.

Regarding the first liquid crystal layer, the following composition A-1 was applied to the alignment film P-1 to form a coating film, the coating film was heated to 80° C. using a hot plate, the coating film was irradiated with ultraviolet light having a wavelength of 365 nm at an irradiation dose of 300 mJ/cm² using a high-pressure mercury lamp in a nitrogen atmosphere. As a result, the alignment of the liquid crystal compound was immobilized.

Regarding the second or subsequent liquid crystal immobilized layer, the composition was applied to the first liquid crystal layer, and the applied composition was heated and irradiated with ultraviolet light for curing under the same conditions as described above. As a result, a liquid crystal immobilized layer was prepared. This way, by repeating the application multiple times until the total thickness reached a desired film thickness, and the liquid crystal layer was formed. The thickness of the liquid crystal layer was 2.0 μm.

It was verified with a polarization microscope that the liquid crystal layer had the phase difference patterns where n=0 to 2 and m=+1 to +3. In addition, the diameter of each of the phase difference patterns was 3.0 mm.

It was verified from the above results that the patterned retardation plate having the plurality of phase difference patterns can be prepared. In addition, it was verified that, by causing linearly polarized light to be incident into each of the phase difference patterns, the linearly polarized light was converted into a plurality of optical vortices.

### EXPLANATION OF REFERENCES

1, 2: optical communication system
10: optical transmitter
11: light source
12: luminous flux expanding element
13: polarizing plate
14: patterned retardation plate
15 to 18: modulator
19: multiplexer
20: optical receiver
21: demultiplexer
22: patterned retardation plate
23 to 26: light-receiving element
30: transmission path
40: optical transmitter
41 to 44: light source
50: liquid crystal compound

What is claimed is:

1. An optical communication system comprising:
an optical transmitter;
a transmission path; and
an optical receiver,
wherein the optical transmitter includes a polarized light source, a patterned retardation plate that converts light from the polarized light source into a plurality of optical vortices, a modulator, and a multiplexer.

2. The optical communication system according to claim 1,
wherein a plurality of the polarized light sources are provided or the single polarized light source is widely distributed, and the modulator is provided between the patterned retardation plate and the multiplexer.

3. The optical communication system according to claim 1,
wherein a plurality of the polarized light sources are provided, and the modulator is provided between each of the polarized light sources and the patterned retardation plate.

4. The optical communication system according to claim 1,
wherein in the patterned retardation plate, an azimuthal angle of an in-plane slow axis changes around one point.

5. The optical communication system according to claim 1,
wherein in the patterned retardation plate, in a case where an azimuthal angle of a slow axis rotates once around one point, the azimuthal angle of the slow axis continuously changes by α×180°, where a represents an integer.

6. The optical communication system according to claim 1, further comprising:
a polarizing plate,
wherein the polarizing plate and the patterned retardation plate are integrated.

7. The optical communication system according to claim 1, comprising:
an alignment mechanism capable of accurately aligning a center of the patterned retardation plate and an incident position of light with each other.

8. The optical communication system according to claim 1,
wherein the patterned retardation plate includes, in the same plane, a plurality of phase difference patterns that are different in at least one of an order or the number of nodes.

9. A patterned retardation plate comprising:
a plurality of phase difference patterns that convert incident polarized light into optical vortices,
wherein the plurality of phase difference patterns that are different in at least one of an order or the number of nodes are provided in the same plane.

10. The optical communication system according to claim 2,
wherein in the patterned retardation plate, an azimuthal angle of an in-plane slow axis changes around one point.

11. The optical communication system according to claim 2,
wherein in the patterned retardation plate, in a case where an azimuthal angle of a slow axis rotates once around one point, the azimuthal angle of the slow axis continuously changes by α×180°, where a represents an integer.

12. The optical communication system according to claim 2, further comprising:
a polarizing plate,
wherein the polarizing plate and the patterned retardation plate are integrated.

13. The optical communication system according to claim 2, comprising:
an alignment mechanism capable of accurately aligning a center of the patterned retardation plate and an incident position of light with each other.

14. The optical communication system according to claim 2,
wherein the patterned retardation plate includes, in the same plane, a plurality of phase difference patterns that are different in at least one of an order or the number of nodes.

15. The optical communication system according to claim 3,
wherein in the patterned retardation plate, an azimuthal angle of an in-plane slow axis changes around one point.

16. The optical communication system according to claim 3,
wherein in the patterned retardation plate, in a case where an azimuthal angle of a slow axis rotates once around one point, the azimuthal angle of the slow axis continuously changes by α×180°, where a represents an integer.

17. The optical communication system according to claim 3, further comprising:
a polarizing plate,
wherein the polarizing plate and the patterned retardation plate are integrated.

18. The optical communication system according to claim 3, comprising:
an alignment mechanism capable of accurately aligning a center of the patterned retardation plate and an incident position of light with each other.

19. The optical communication system according to claim 3,
wherein the patterned retardation plate includes, in the same plane, a plurality of phase difference patterns that are different in at least one of an order or the number of nodes.

20. The optical communication system according to claim 4,
wherein in the patterned retardation plate, in a case where an azimuthal angle of a slow axis rotates once around one point, the azimuthal angle of the slow axis continuously changes by α×180°, where a represents an integer.
